(19) United States
(12) Patent Application Publication
(10) Pub. No.: US 2026/0149871 A1
(43) Pub. Date: May 28, 2026

(54) IMAGING APPARATUS, CONTROL METHOD, STORAGE MEDIUM, AND IMAGING SYSTEM

(71) Applicant: CANON KABUSHIKI KAISHA, Tokyo (JP)

(72) Inventor: TOSHIO TAKEUCHI, Kanagawa (JP)

(21) Appl. No.: 19/388,749

(22) Filed: Nov. 13, 2025

(30) Foreign Application Priority Data
Nov. 25, 2024 (JP) 2024-204635

(51) Int. Cl. H04N 23/63; G06T 7/73

(52) U.S. Cl. CPC H04N 23/632; G06T 7/75; G06T 2207/30196

(57) ABSTRACT

An imaging apparatus estimates multiple skeleton landmarks in a representation of a person to be imaged included in a captured image, obtains a pose change instruction based on designation of a position after movement of at least one of the skeleton landmarks by a user, generates a pose instruction image corresponding to the change instruction, and transmits the pose instruction image to a display device viewable by the person to be imaged.

### BACKGROUND

### FIELD OF THE TECHNOLOGY

The present disclosure relates to a technique of assisting imaging.

### DESCRIPTION OF THE RELATED ART

There is a technique of estimating a posture or a skeleton of a person or the like as a subject to be imaged (hereinafter, referred to as a "subject") prior to imaging, which may allow a photographer to perform imaging more easily to obtain an image with a desired composition. Japanese Patent Laid-Open No. 2017-532922 (hereinafter, referred to as "PTL 1") discloses a technique of issuing a voice message to prompt a person as a subject to change the posture in a case where a posture of the person set in advance does not match the posture of the person as the subject.

However, the technique disclosed in PTL 1 is not seen to change the posture. Therefore, the technique disclosed in PTL 1 has had a problem that the person as the subject cannot perceive how to change the own posture. Therefore, there has been a problem that imaging cannot be performed properly.

### SUMMARY

An imaging apparatus according to the present disclosure is configured to: estimate multiple skeleton landmarks in a representation of a person to be imaged included in a captured image; obtain a pose change instruction based on designation of a position after movement of at least one of the skeleton landmarks by a user; generate a pose instruction image corresponding to the change instruction; and transmit the pose instruction image to a display device viewable by the person to be imaged.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of an imaging system according to a first embodiment.

FIG. 2 is a block diagram illustrating an example of a hardware configuration of an imaging apparatus and a display device according to the first embodiment.

FIG. 3 is a block diagram illustrating an example of a logical configuration of the imaging apparatus and the display device according to the first embodiment.

FIG. 4 is a flowchart illustrating an example of a processing flow of the imaging apparatus according to the first embodiment.

FIG. 5 is a diagram illustrating an example of a live view image according to the first embodiment.

FIG. 6 is a diagram illustrating an example of a configuration and a learning method of a skeleton estimation DL model according to the first embodiment.

FIGS. 7A and 7B are diagrams illustrating an example of a skeleton landmark image according to the first embodiment.

FIGS. 8A to 8C are diagrams illustrating an example of a pose instruction input screen according to the first embodiment.

FIGS. 9A to 9D are diagrams illustrating an example of a display image according to the first embodiment.

FIG. 10 is a block diagram illustrating an example of a logical configuration of the imaging apparatus and the display device according to a second embodiment.

FIG. 11 is a flowchart illustrating an example of a processing flow of the imaging apparatus according to the second embodiment.

FIG. 12 is a diagram illustrating an example of a pose instruction input screen according to the second embodiment.

FIG. 13 is a diagram illustrating an example of skeleton motion range data according to the second embodiment.

FIGS. 14A to 14C are diagrams illustrating an example of a pose instruction image corresponding to an alternative pose according to the second embodiment.

FIGS. 15A to 15C are diagrams illustrating an example of a display image according to the second embodiment.

FIG. 16 is a diagram illustrating an example of a configuration of the imaging system according to a third embodiment.

FIG. 17 is a diagram illustrating a hardware configuration of the imaging apparatus and the display device according to the third embodiment.

FIG. 18 is a block diagram illustrating an example of a logical configuration of the imaging apparatus and the display device according to the third embodiment.

FIG. 19 is a diagram illustrating an example of a live view image according to the third embodiment.

FIG. 20 is a diagram illustrating an example of a skeleton landmark image according to the third embodiment.

FIG. 21 is a diagram illustrating an example of a pose instruction input screen according to the third embodiment.

FIGS. 22A to 22C are diagrams illustrating an example of a display image according to the third embodiment.

### DESCRIPTION OF THE EMBODIMENTS

Hereinafter, with reference to the attached drawings, the present disclosure is explained in detail in accordance with preferred embodiments. Configurations illustrated in the following embodiments are merely exemplary and the present disclosure is not limited to the illustrated configurations.

### Embodiment 1

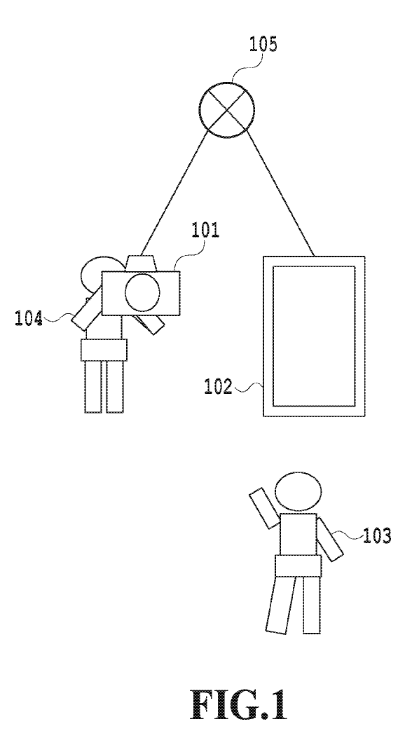

FIG. 1 is a diagram illustrating an example of a configuration of an imaging system according to an Embodiment 1. The imaging system includes an imaging apparatus 101 and a display device 102. The imaging apparatus 101 and the display device 102 are communicably connected to each other via a network 105. Hereinafter, a case where the imaging system includes a single imaging apparatus 101 is described. The imaging apparatus 101 is an apparatus having an imaging function and a communication function, such as a digital still camera, a digital video camera, a smartphone, or the like. The display device 102 is a device to display a received image, such as a television receiver, a display for a personal computer (PC), or the like.

The imaging apparatus 101 accepts an input of a pose change instruction (hereinafter, referred to as a "pose instruction") from a photographer 104 who is a user of the imaging apparatus 101 and transmits data on an image related to the pose instruction to the display device 102 via the network 105. The display device 102 displays the image related to the pose instruction that is received from the imaging apparatus 101. A person 103 as a subject to be imaged (hereinafter, referred to as a "subject") poses according to the image related to the pose instruction that is displayed on the display device 102.

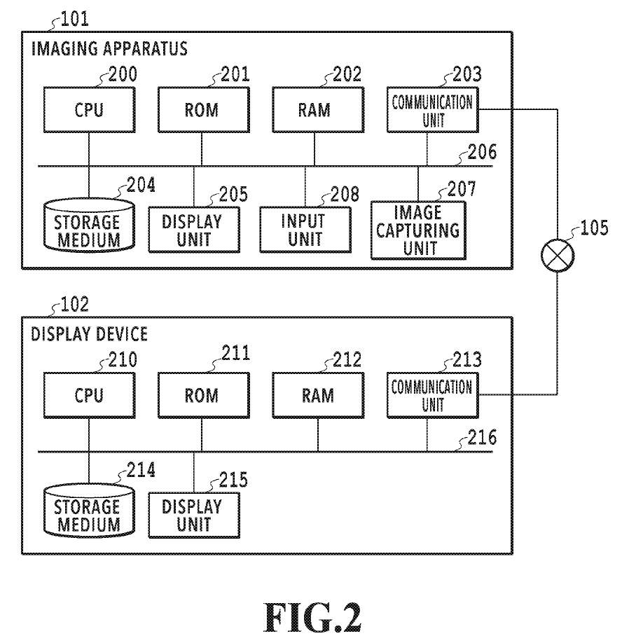

FIG. 2 is a block diagram illustrating an example of a hardware configuration of the imaging apparatus 101 and the display device 102 according to the present embodiment. The hardware configuration of the imaging apparatus 101 includes a CPU 200, a ROM 201, a RAM 202, a communication unit 203, a storage medium 204, a display unit 205, an input unit 208, and an image capturing unit 207. The components of the hardware configuration of the imaging apparatus 101 are communicably connected to each other via a bus 206. The CPU 200 is a control unit including at least one processor or processing circuit and controls the imaging apparatus 101. The ROM 201 is a memory that may perform deleting and recording electrically, and various data, programs, and the like used for processing by the CPU 200 are stored. The program mentioned herein is a computer program to execute processing of various flowcharts of the present embodiment described below. The RAM 202 is a memory used as a working area of the CPU 200, and the data used for the processing by the CPU 200, the program read out from the ROM 201, and the like are loaded into the RAM 202.

The communication unit 203 is an interface for communication with an external device such as network equipment or a USB device and establishes data communication via the network 105 or transmits and receives data to and from the external device. The storage medium 204 is a non-volatile memory, such as a semiconductor memory or the like such as a memory card. The input unit 208 is a device such as a button, a touch panel, or the like that accepts an input from the photographer 104. The display unit 205 is a display device such as a liquid crystal monitor and displays a graphical user interface (GUI) related to a state of an operation, change in setting, and the like of the imaging apparatus 101. The image capturing unit 207 is an image capturing element, such as a charge coupled device (CCD), a complementary metal-oxide semiconductor (CMOS) element, or the like that converts an optical image into an electric signal. The CPU 200 also operates as a control unit that controls the input unit 208, the display unit 205, and the image capturing unit 207.

The hardware configuration of the display device 102 includes a CPU 210, a ROM 211, a RAM 212, a communication unit 213, a storage medium 214, and a display unit 215. The components of the hardware configuration of the display device 102 are communicably connected to each other via a bus 216. The CPU 210 is a control unit including at least one processor or processing circuit and controls the display device 102. The ROM 211 is a memory that may perform deleting and recording electrically, and store various data, programs, and the like used for processing by the CPU 210. The program is a computer program to execute processing of the various flowcharts of the present embodiment described below. The RAM 212 is a memory used as a working area of the CPU 210, and the data used for the processing by the CPU 210, the program read out from the ROM 211, and the like are loaded into the RAM 212.

The communication unit 213 is an interface for communication with an external device such as network equipment or a USB device and establishes data communication via the network 105 or transmits and receives data to and from the external device. The storage medium 214 is a non-volatile memory, such as a semiconductor memory or the like, such as a memory card. The display unit 215 is a display device such as a liquid crystal monitor and displays the image obtained via the communication unit 213.

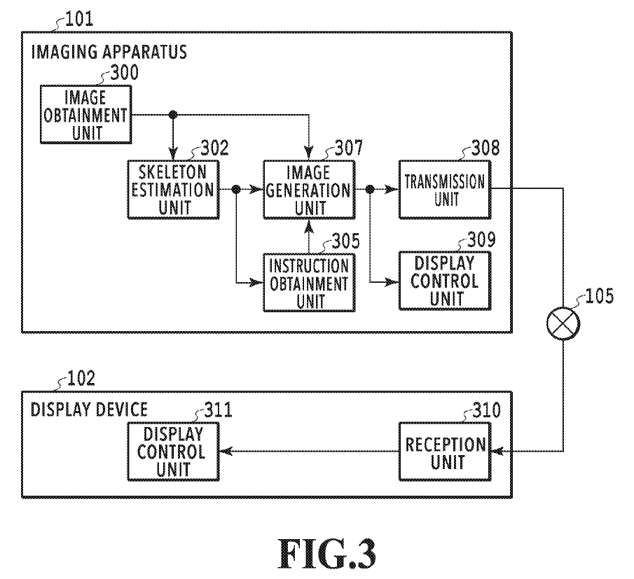

FIG. 3 is a block diagram illustrating an example of a logical configuration of the imaging apparatus 101 and the display device 102 according to the present embodiment. The logical configuration of the imaging apparatus 101 includes an image obtainment unit 300, a skeleton estimation unit 302, an instruction obtainment unit 305, an image generation unit 307, a transmission unit 308, and a display control unit 309. Each logical configuration included in the imaging apparatus 101 is implemented by the CPU 200 loading the program stored in the ROM 201 into the RAM 202 and executing the program.

The image obtainment unit 300 obtains an image obtained by an imaging operation by the image capturing unit 207 as a live view image and saves data of the obtained live view image into the storage medium 204. The skeleton estimation unit 302 estimates a skeleton landmark in a representation of the person 103 as the subject, which is included in the live view image obtained by the image obtainment unit 300, and obtains skeleton landmark data. Specifically, for example, first, the skeleton estimation unit 302 inputs the data on the live view image into a skeleton estimation Deep Learning (DL) model obtained as a result of learning performed by machine learning and the like. Then, the skeleton estimation unit 302 obtains the skeleton landmark data outputted as an estimation result from the skeleton estimation DL model. A configuration and a learning method of the skeleton estimation DL model are described below. The skeleton landmark data obtained by the skeleton estimation unit 302 is converted into a skeleton landmark image by the image generation unit 307, and the skeleton landmark image is displayed on the display unit 205 via the display control unit 309. The following description is provided assuming that the skeleton landmark image is displayed on the display unit 205 in a state of being superimposed on the live view image.

The instruction obtainment unit 305 obtains the pose instruction from the photographer 104 that is accepted by the input unit 208 and saves data on the obtained pose instruction (hereinafter, referred to as "pose instruction data") into the storage medium 204. For example, the photographer 104 inputs the pose instruction with reference to the skeleton landmark image displayed on the display unit 205. The pose instruction obtained by the instruction obtainment unit 305 is converted into the form of an image as the pose instruction image by the image generation unit 307, and the pose instruction image is displayed on the display unit 205 via the display control unit 309. Specifically, for example, the image generation unit 307 generates a display image obtained by superimposing the pose instruction image, the live view image, and the skeleton landmark image on each other, and the display control unit 309 displays the display image generated by the image generation unit 307 on the display unit 205. Additionally, the pose instruction image is transmitted to the display device 102 as the display image via the transmission unit 308 and the network 105. Specifically, for example, the image generation unit 307 generates the display image obtained by superimposing the pose instruction image on the live view image, and the transmission unit 308 transmits the display image generated by the image generation unit 307 to the display device 102 via the network 105.

The logical configuration of the display device 102 includes a reception unit 310 and a display control unit 311. Each logical configuration included in the display device 102 is implemented with the CPU 210 loading the program stored in the ROM 211 into the RAM 212 and executing the program. The reception unit 310 receives data on the display image transmitted from the imaging apparatus 101. The display control unit 311 displays the display image received by the reception unit 310 on the display unit 215.

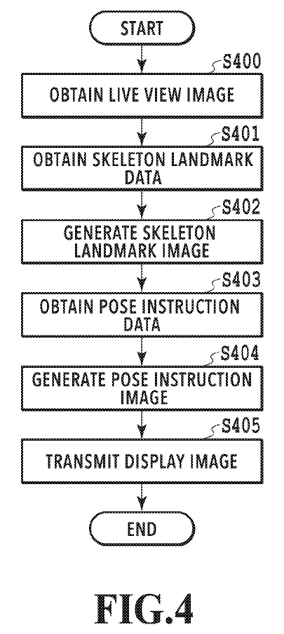

FIG. 4 is a flowchart illustrating an example of a processing flow of the imaging apparatus 101 according to the present embodiment. The processing in the flowchart illustrated in FIG. 4 is implemented with the CPU 200 in the imaging apparatus 101 loading the program stored in the ROM 201 into the RAM 202 and executing the program. A part of or all of the processing in the flowchart illustrated in FIG. 4 may be executed by a processing circuit.

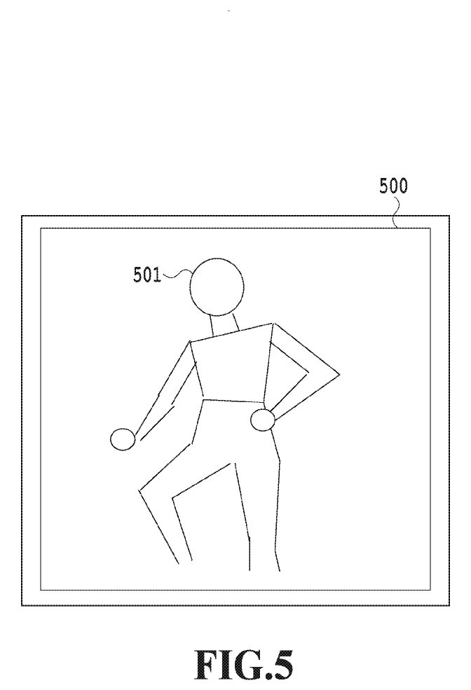

In S400, the image obtainment unit 300 obtains the live view image. The data on the live view image obtained by the image obtainment unit 300 is saved into the storage medium 204 and is displayed on the display unit 205 via the display control unit 309. FIG. 5 is a diagram illustrating an example of a live view image 500 displayed on the display unit 205 according to the present embodiment. The live view image 500 includes a representation 501 of the person 103 as the subject. Next, in S401, the skeleton estimation unit 302 estimates the skeleton landmark in the representation 501 of the person 103 as the subject included in the live view image 500 obtained in S400 and obtains the skeleton landmark data. The skeleton landmark data obtained by the skeleton estimation unit 302 is saved into the storage medium 204.

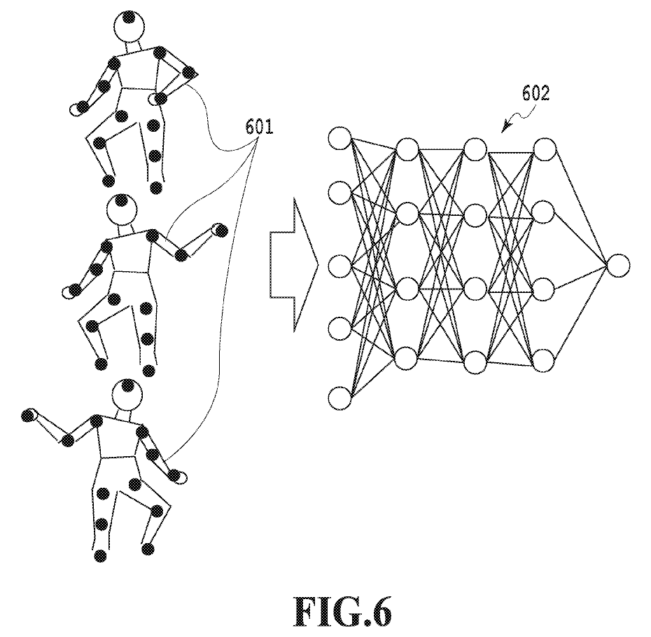

The skeleton estimation DL model used by the skeleton estimation unit 302 to estimate the skeleton landmark is described with reference to FIG. 6. FIG. 6 is a diagram illustrating an example of the configuration and the learning method of a skeleton estimation DL model 602 according to the present embodiment. The skeleton estimation DL model 602 includes an input layer, one or more intermediate layers, and an output layer, and each layer includes one or more nodes. The image corresponding to each frame in the live view image is inputted to the input layer of the skeleton estimation DL model 602 as learning data. As an estimation result of the skeleton landmark corresponding to the image inputted to the input layer, the skeleton landmark data is outputted from the output layer of the skeleton estimation DL model 602.

In the learning of the skeleton estimation DL model 602, first, a difference between skeleton landmark data 601, which is Ground Truth data corresponding to the image inputted to the input layer, and the skeleton landmark data outputted from the output layer is calculated by a loss function and the like. Then, a weight parameter of each node included in the intermediate layer is updated by an error back-propagation method and the like to make the difference smaller. For example, the learned skeleton estimation DL model 602 is obtained by repeatedly performing the above-described processing until the above-described difference falls within a predetermined range.

Returning to FIG. 4, in S402, the image generation unit 307 generates the skeleton landmark image obtained by converting the skeleton landmark data obtained in S401 into the form of an image. The skeleton landmark image generated by the image generation unit 307 is displayed on the display unit 205 via the display control unit 309. The image generation unit 307 may generate the image obtained by superimposing the generated skeleton landmark image on the live view image obtained in S400. In this case, the image generated by the image generation unit 307 is displayed on the display unit 205 via the display control unit 309.

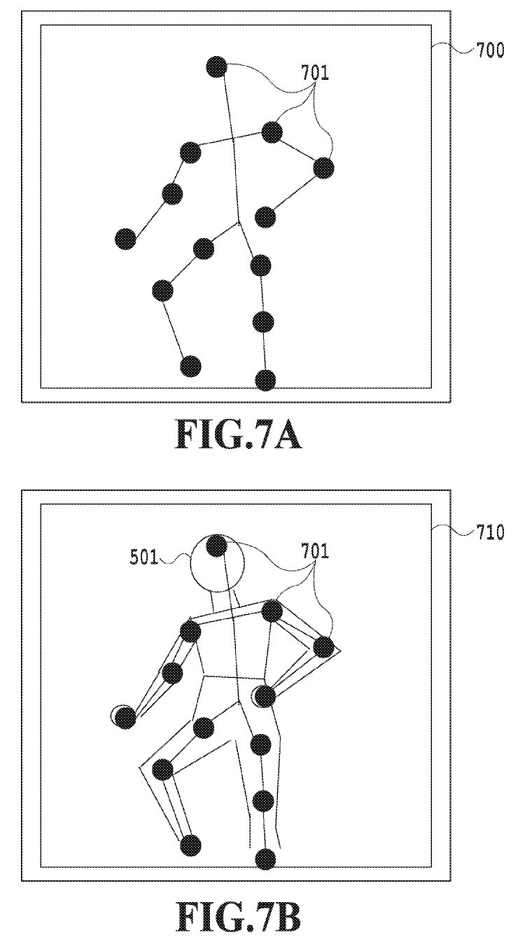

FIGS. 7A and 7B are diagrams illustrating an example of the skeleton landmark image displayed on the display unit 205 according to the present embodiment. FIG. 7A illustrates an example of a skeleton landmark image 700 generated by the image generation unit 307. FIG. 7B illustrates an example of a skeleton landmark image 710 generated with the image generation unit 307 superimposing the skeleton landmark image 700 on the live view image 500. A black circle 701 is the skeleton landmark corresponding to an important portion in the skeleton such as an acromion and the top of a head in the representation 501 of the person 103 as the subject.

A coordinate indicating a position of each skeleton landmark and information indicating a connection relationship between the skeleton landmarks are stored in the skeleton landmark data. In FIG. 7A and 7B, the connection relationship between the associated skeleton landmarks is expressed by a line segment connecting the black circles 701. In other words, a list of the skeleton landmarks, a three-dimensional coordinate of each skeleton landmark, and information related to another skeleton landmark connected to each skeleton landmark are stored in the skeleton landmark data. The connection relationship between the skeleton landmarks, a distance between the skeleton landmarks connected to each other, and the like may be calculated by processing the skeleton landmark data. For example, a distance between the acromion and an elbow may be specified as a length comparable to a length of an upper arm. The distance may be calculated based on the three-dimensional coordinates of the skeleton landmarks corresponding to the acromion and the elbow and the information indicating the connection relationship between the skeleton landmarks.

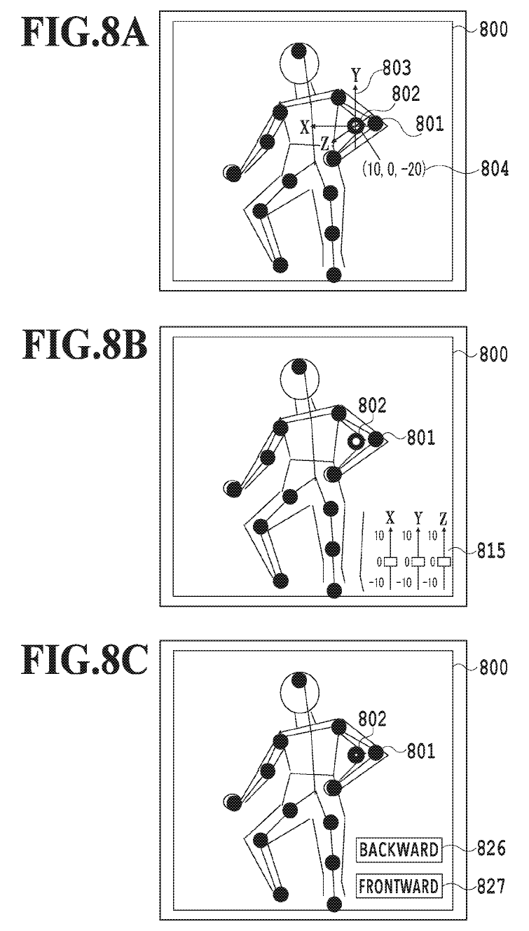

Returning to FIG. 4, in S403, the instruction obtainment unit 305 obtains the pose instruction from the photographer 104 that is accepted by the input unit 208 and saves the pose instruction data into the storage medium 204. FIGS. 8A to 8C are diagrams illustrating an example of a pose instruction input screen 800 displayed on the display unit 205 according to the present embodiment. A method of inputting the pose instruction by the photographer 104 will be described with reference to FIG. 8A. The following description is provided assuming that the display unit 205 and the input unit 208 are a liquid crystal panel and a touch sensor or a touch panel, where the photographer 104 inputs the pose instruction by performing touch manipulation on the pose instruction input screen 800 displayed on the display unit 205. For example, the photographer 104 touches an arbitrary skeleton landmark from the multiple skeleton landmarks displayed in the skeleton landmark image 710 illustrated in FIG. 7B and selects the skeleton landmark as a movement target skeleton landmark. An example where the photographer 104 selects a skeleton landmark 801 as the movement target skeleton landmark (hereinafter, referred to as a "target landmark") illustrated in FIGS. 8A to 8C will be described.

In a case where the skeleton landmark 801 is selected as the target landmark, the imaging apparatus 101 displays a skeleton landmark 802 and a GUI component 803 for the pose instruction near the skeleton landmark 801. The GUI component 803 is a GUI component expressed by an X-axis, a Y-axis, and a Z-axis and may enable the photographer 104 to input a movement direction. For example, in a case where the photographer 104 selects the X-axis in the GUI component 803 by touching, the photographer 104 may move the skeleton landmark 802 for the pose instruction only in an X-axis direction. In a case where the photographer 104 selects the Y-axis or the Z-axis in the GUI component 803, the photographer 104 may move the skeleton landmark 802 for the pose instruction only in a direction of the selected axis.

Each movement, for example, in the X-axis direction and the Y-axis direction is expressed by a display position of the skeleton landmark 802 in a horizontal direction and a vertical direction on the pose instruction input screen 800. The movement in the Z-axis direction is expressed by, for example, display of a three-dimensional coordinate 804 of the skeleton landmark 802. The expression of the movement in the Z-axis direction is not limited thereto and may be expressed by changing a form such as a shape of the skeleton landmark 802. For example, the movement in the Z-axis direction may be expressed by a size of a white circle in the skeleton landmark 802. More specifically, , the more the skeleton landmark 802 is moved in a positive direction of the Z-axis, the more the size of the white circle is increased, and the more the skeleton landmark 802 is moved in a negative direction of the Z-axis, the more the size of the white circle is decreased.

FIGS. 8B and 8C illustrate other aspects of the pose instruction input screen 800. The pose instruction input screen 800 illustrated in FIG. 8B includes a slider bar 815 to input a movement amount in the direction of each axis as the GUI component for the pose instruction. The photographer 104 designates the position of the skeleton landmark 802 for the pose instruction by changing a tab position of the slider bar 815.

The pose instruction input screen 800 illustrated in FIG. 8C includes a "backward" button 826 and a "forward" button 827 as the GUI component for the pose instruction. With respect to the movement in the X-axis direction and the Y-axis direction, the photographer 104 designates a position of the movement destination by touching the position to which the photographer 104 wants to move the skeleton landmark 802 on the pose instruction input screen 800. With respect to the movement in the Z-axis direction, the photographer 104 provides instructions regarding the movement by touching the "backward" button 826 or the "forward" button 827. The skeleton landmark 802 on the pose instruction input screen 800 illustrated in FIG. 8C is an example in a case where the skeleton landmark 802 is moved backward by pressing the "backward" button. In the example illustrated in FIG. 8C, the backward movement of the skeleton landmark 802 is expressed by decreasing the size of the white circle inside.

Returning to FIG. 4, in S404, the image generation unit 307 generates the pose instruction image by using the live view image, the pose instruction data, and the skeleton landmark data obtained in S400, S401, or S403. The pose instruction image generated by the image generation unit 307 is displayed as the display image on the display unit 205 via the display control unit 309. The image generation unit 307 may generate the image obtained by superimposing the generated pose instruction image on the live view image obtained in S400 as the display image. The image generation unit 307 may generate the image obtained by superimposing the generated pose instruction image on the live view image obtained in S400 and the skeleton landmark image generated in S402 as the display image. The display image generated by the image generation unit 307 is displayed to the photographer 104 on the display unit 205 via the display control unit 309.

Next, in S405, the transmission unit 308 transmits the data on the display image generated in S404 to the display device 102 via the network 105. The display device 102 receives the data on the display image transmitted in S405 and displays the display image on the display unit 215 to the person 103 as the subject. The display image displayed on the display unit 205 and the display image transmitted to the display device 102 via the network 105 may be the same or may be different. That is, the display image for the photographer 104 and the display image for the person 103 as the subject may be the same or may be different. After S405, the imaging apparatus 101 ends the processing of the flowchart illustrated in FIG. 4.

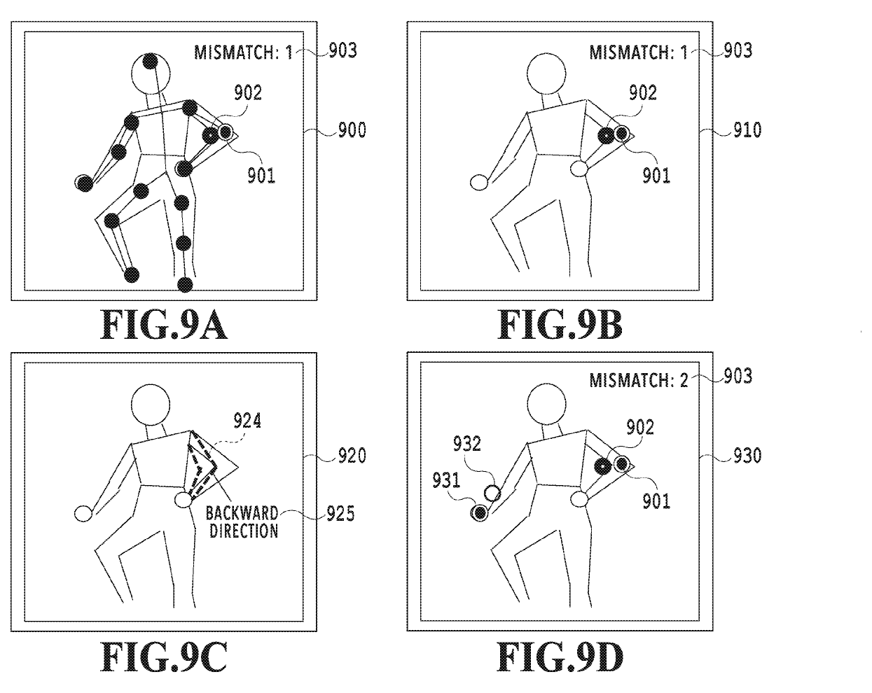

FIGS. 9A to 9D are diagrams illustrating an example of the display image displayed on the display unit 205 or the display unit 215 according to the present embodiment. In a display image 900 illustrated in FIG. 9A, a position of a target landmark 901 and a position of a skeleton landmark 902 after movement of the target landmark 901, which corresponds to the pose instruction, is displayed. The target landmark 901 and the skeleton landmark 902 after the movement are expressed by a form enabling the photographer 104 and the person 103 as the subject to distinguish the direction of the movement of the target landmark 901 in a front-back direction. Specifically, the target landmark 901 is expressed by a form of a white circle including a black circle therein, while the skeleton landmark 902 after the movement is expressed by a form of a black circle including a white circle therein. The skeleton landmark 901 indicates that the position of the skeleton landmark is in front of a reference position. The skeleton landmark 902 indicates that the position of the skeleton landmark is behind the reference position.

A displacement amount of the position of the skeleton landmark from the reference position in the front-back direction may be expressed by a size of an inner circle included in an outer circle. According to the displacement of the position of the skeleton landmark in the frontward direction with respect to the reference position, the inner black circle is enlarged, while according to the displacement of the position of the skeleton landmark in the backward direction with respect to the reference position, the inner white circle is enlarged. The person 103 as the subject may perceive a part of a body of the person 103 to be moved, an amount of the movement, and the direction thereof by confirming the display image displayed on the display unit 215. The above-described expression method of the displacement amount in the front-back direction is merely an example, and is not seen to be limiting.

In the display image 900 illustrated in FIG. 9A, information 903 indicating the number of mismatch is included. The number of mismatch is the number of the target landmark 901 of the person 103 as the subject that is in a position not matching the position of the skeleton landmark 902 for the pose instruction. For example, the imaging apparatus 101 determines whether the distance between the skeleton landmark 902 for the pose instruction and the target landmark 901 of the person 103 as the subject is within a predetermined threshold and counts the number of the target landmark 901 that has the distance not within the threshold. In this case, the above-described threshold may be provided in advance as a default value of the system or may be provided by an input by the photographer 104. The number of mismatch is not limited to the number of the target landmark 901 in the position mismatching that of the skeleton landmark for the pose instruction. For example, in a case where the person 103 as the subject changes the posture based on the pose instruction image and the like, the imaging apparatus 101 may also count the number of the skeleton landmark that is not provided with the pose instruction and is in a position displaced from the initial position as the number of mismatch.

In a case where the person 103 as the subject poses based on the instruction, the number of mismatch is 0. In a case where the position of the skeleton landmark 902 for the pose instruction matches the position of the target landmark 901 of the person 103 as the subject, the imaging apparatus 101 may generate, display, and transmit the display image as described below. Specifically, for example, in this case, the imaging apparatus 101 expresses the matching between the positions by changing at least one of the shape, the color, or the transparency in the expression of the skeleton landmark 902 or the target landmark 901 in the display image.

A display image 910 illustrated in FIG. 9B is obtained by superimposing the pose instruction image including only the target landmark 901 out of the skeleton landmarks estimated in S402 and the skeleton landmark 902 for the pose instruction on the live view image. The imaging apparatus 101 may generate, display, and transmit the above-described display image 910. A display image 920 illustrated in FIG. 9C is obtained by superimposing the pose instruction image including a body line 924 in a case of moving the skeleton landmark based on the pose instruction, instead of the skeleton landmark of the person 103, on the live view image. The body line 924 may be a contour of the body expressed by a broken line or the like. The body line 924 may be expressed by an imagery image or the like in a case of designated posing, which is generated by utilizing generative artificial intelligence (AI), image processing, or the like. The frontward direction or the backward direction may be expressed by using a caption 925 or by the imagery image.

A display image 930 illustrated in FIG. 9D is the display image generated by the expression method as with that of the display image 900 illustrated in FIG. 9A and is the display image in a case where there are two target landmarks 901 and 931. In the display image 930, the skeleton landmark 902 for the pose instruction indicates that it is better to move the target landmark 901 in the backward direction by expressing the inner white circle small. The skeleton landmark 932 for the pose instruction indicates that it is better to move the target landmark 931 in the frontward direction by expressing the inner white circle large.

According to the above-described imaging system, the person as the subject may perceive how to change the person’s own posture. As a result, the photographer is provided assistance in properly performing an imaging operation.

### Embodiment 2

In Embodiment 1, an aspect of displaying the image based on the pose instruction (the pose instruction image) as the display image to the person 103 as the subject is described. However, in some cases, the pose based on the pose instruction is a pose that can never be realized by a person. According to an aspect of an Embodiment 2, the pose instruction image is generated by considering a skeleton motion range of a person 103 as the subject is described.

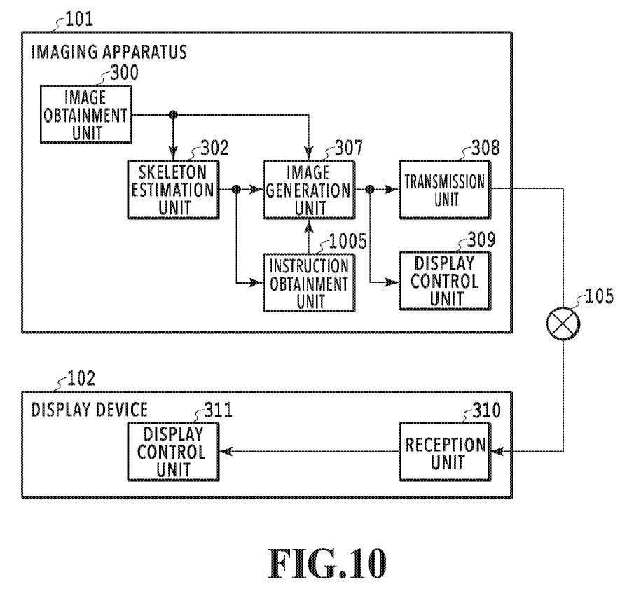

FIG. 10 is a block diagram illustrating an example of a logical configuration of the imaging apparatus 101 and the display device 102 according to the present embodiment. The imaging apparatus 101 of the present embodiment is similar to the imaging apparatus 101 of Embodiment 1 except that the instruction obtainment unit 305 of Embodiment 1 is changed to an instruction obtainment unit 1005. The logical configuration of the display device 102 according to the present embodiment is similar to the logical configuration of the display device 102 according to Embodiment, and as such, the description is omitted herein.

The instruction obtainment unit 1005 obtains the pose instruction of the photographer 104 that is accepted by the input unit 208. In addition to the above-described processing, the instruction obtainment unit 1005 utilizes skeleton motion range data stored in advance in the ROM 201 and the like to determine whether the pose instructed by the photographer 104 may be realized within a motion range of the skeleton of the person 103. If it is determined that the pose instructed by the photographer 104 may be realized by the person 103, the instruction obtainment unit 1005 saves data on the obtained pose instruction (the pose instruction data) into the storage medium 204. If it is determined that the pose instructed by the photographer 104 can never be realized by the person 103, the instruction obtainment unit 1005 obtains an alternative that is close to the pose instructed by the photographer 104 and is the pose that may be realized by the person 103. In this case, the instruction obtainment unit 1005 saves data on the obtained alternative into the storage medium 204 as the pose instruction data.

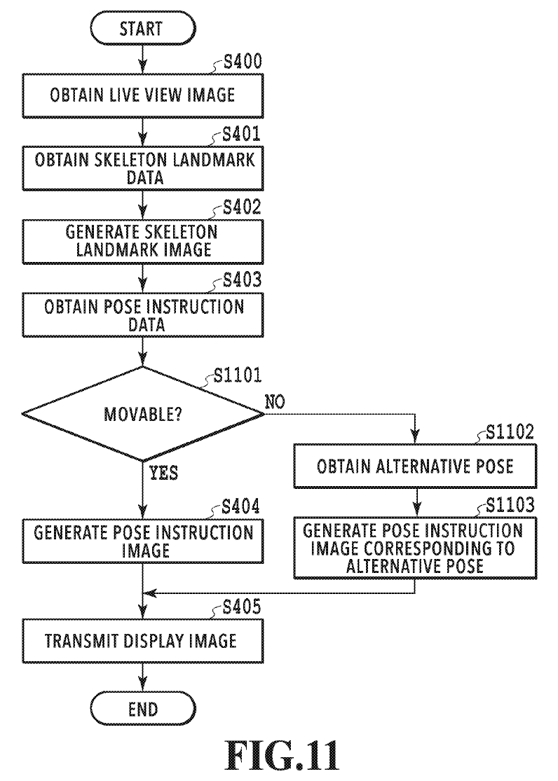

FIG. 11 is a flowchart illustrating an example of a processing flow of the imaging apparatus 101 according to the present embodiment. In the processing in the flowchart illustrated in FIG. 11, processing similar to the processing in the flowchart illustrated in FIG. 4 is provided with the same reference signs, and the descriptions are omitted herein. The imaging apparatus 101 executes the processing from S400 to S403. Next, in S1101, the instruction obtainment unit 1005 determines whether the pose instructed by the photographer 104 may be realized within the motion range of the skeleton of the person 103 based on the pose instruction from the photographer 104 obtained in S403.

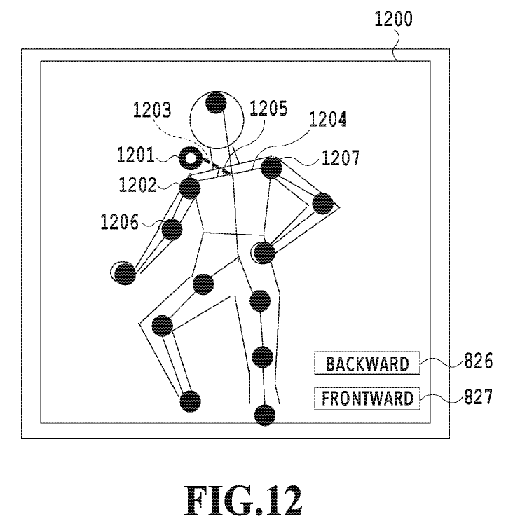

FIG. 12 is a diagram illustrating an example of a pose instruction input screen 1200 displayed on the display unit 205 according to the present embodiment. On the pose instruction input screen 1200, a skeleton landmark 1201 is the skeleton landmark for the pose instruction set based on an input by the photographer 104. The skeleton landmark 1201 is the skeleton landmark indicating the movement destination of a movement target skeleton landmark 1202 instructed by an input by the photographer 104. The instruction obtainment unit 1005 determines whether the skeleton landmark 1202 may be moved to the position of the skeleton landmark 1201 by only moving the skeleton landmark 1202.

As described above, the list of the skeleton landmarks, the three-dimensional coordinate of each skeleton landmark, and the information related to the other skeleton landmark connected to each skeleton landmark are stored in the skeleton landmark data. To perform the above-described determination, the instruction obtainment unit 1005 calculates a three-dimensional angle and a length between the skeleton landmarks by using the skeleton landmark data. Subsequently, the instruction obtainment unit 1005 determines whether the skeleton landmark 1202 may be moved to the position of the skeleton landmark 1201 by only moving the skeleton landmark 1202 by using an inverse-kinematic equation.

The instruction obtainment unit 1005 specifies the skeleton landmark connected directly or indirectly with the movement target skeleton landmark 1202. In a case where the movement target skeleton landmark 1202 corresponding to a right shoulder of the person 103 is moved in an upward direction as the example illustrated in FIG. 12, the skeleton landmarks connected directly or indirectly to the skeleton landmark 1202 are also drawn in the upward direction. In this case, a skeleton landmark 1206 corresponding to a right elbow and the skeleton landmark corresponding to a right wrist are also drawn in the upward direction. A skeleton landmark 1207 corresponding to a shoulder on an opposite side (a left shoulder) and the like connected directly or indirectly to the movement target skeleton landmark 1202 are also drawn in the direction of the skeleton landmark 1201 for the pose instruction.

The instruction obtainment unit 1005 then uses the inverse-kinematic equation and calculates a movement amount of the skeleton landmark other than the target landmark in a case where the target landmark is moved. Based on a result of the calculation, the instruction obtainment unit 1005 then determines whether only the target landmark may be moved within the skeleton motion range of the natural person without moving the skeleton landmark other than the target landmark.

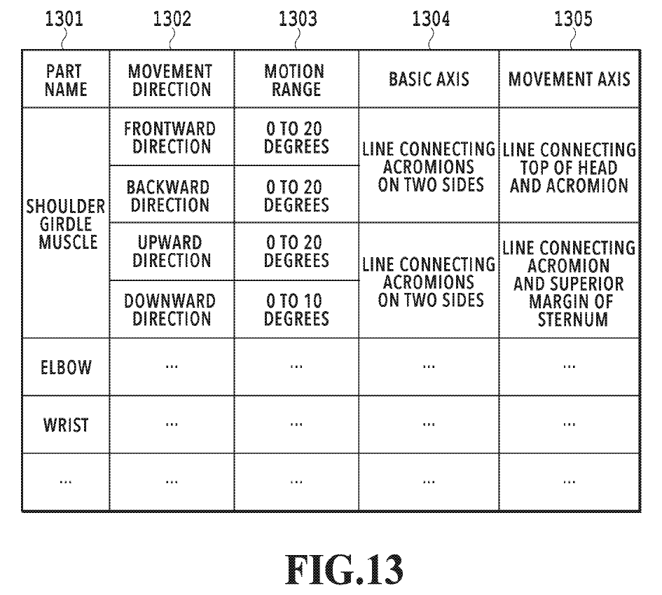

FIG. 13 is a diagram illustrating an example of the skeleton motion range data according to the present embodiment. The skeleton motion range data includes part name 1301, movement direction 1302, motion range 1303, basic axis 1304, and movement axis 1305 as items. In the part name 1301, information indicating a name of the part that may be estimated as the skeleton landmark in S401 is stored as an item value. For example, the skeleton landmark corresponding to a shoulder girdle is the skeleton landmark 1202 in FIG. 12. In the movement direction 1302, information indicating the direction in which each skeleton landmark is to be moved is stored as the item value. In the motion range 1303, information indicating a range in which an average natural person may move in the direction stored in the movement direction 1302 as the item value is stored as the item value. In the basic axis 1304, information indicating a reference direction in a case where an angle of the movement direction stored in the movement direction 1302 as the item value is stored. In the movement axis 1305, information indicating another direction that forms the angle with the reference direction stored in the basic axis 1304 as the item value in a case of calculating the angle of the movement direction stored in the movement direction 1302 as the item value is stored.

With respect to the skeleton landmark 1202 corresponding to the shoulder girdle, in a case where the movement direction is an up-down direction, the basic axis is comparable to a line segment 1204 indicated by a solid line, and the movement axis is comparable to a line segment 1205 indicated by a broken line. Therefore, a movement angle 1203 in the upward direction of the skeleton landmark 1202 corresponding to the shoulder girdle is obtained by calculating the angle formed by the line segment 1204 and the line segment 1205.

An exemplary case where the movement angle 1203 of the skeleton landmark 1202 in the pose instruction from the photographer 104 is 30 degrees will now be described. According to the skeleton motion range data illustrated in FIG. 13 as an example, the motion range in the upward direction of the average natural person for the skeleton landmark 1202 corresponding to the shoulder girdle is 0 to 20 degrees. Therefore, it is impossible to only move the skeleton landmark 1202 to the position of the skeleton landmark 1201 for the pose instruction in the upward direction. Accordingly, in this case, in S1101, it is determined that the pose instructed by the photographer 104 can never be realized within the motion range of the skeleton of the natural person.

If it is determined in S1101 that the pose instructed by the photographer 104 may be realized within the motion range of the skeleton of the person 103, the imaging apparatus 101 executes the processing in S404 and S405 and ends the processing in the flowchart illustrated in FIG. 11. If it is determined in S1101 that the pose instructed by the photographer 104 can never be realized within the motion range of the skeleton of the person 103, the instruction obtainment unit 1005 executes processing in S1102. Specifically, in this case, in S1102, the instruction obtainment unit 1005 obtains the alternative that is close to the pose instructed by the photographer 104 and is the pose that may be realized by the person 103. In an exemplary case to be described, the movement angle 1203 of the skeleton landmark 1202 in the pose instruction from the photographer 104 is 30 degrees, and the motion range of the average natural person is 0 to 20 degrees. While the pose instruction from the photographer 104 in this case is the angle that cannot be realized by the average person 103, a person having some flexibility may realize the pose. Based on the above-described circumstance, the instruction obtainment unit 1005 obtains the alternative pose that may be realized by the person 103. In this case, the instruction obtainment unit 1005 saves the data on the obtained alternative into the storage medium 204 as the pose instruction data.

Next, in S1103, the image generation unit 307 generates the pose instruction image by using the data on the alternative pose that may be realized by the person 103 obtained in S1102 and the live view image and the skeleton landmark data obtained in S400 or S401. The pose instruction image generated in S1103 is the pose instruction image corresponding to the alternative pose. The processing in S1103 is similar to the processing in S404 illustrated in FIG. 4, except that the data on the alternative is used instead of the pose instruction data; and as such, the description is omitted herein.

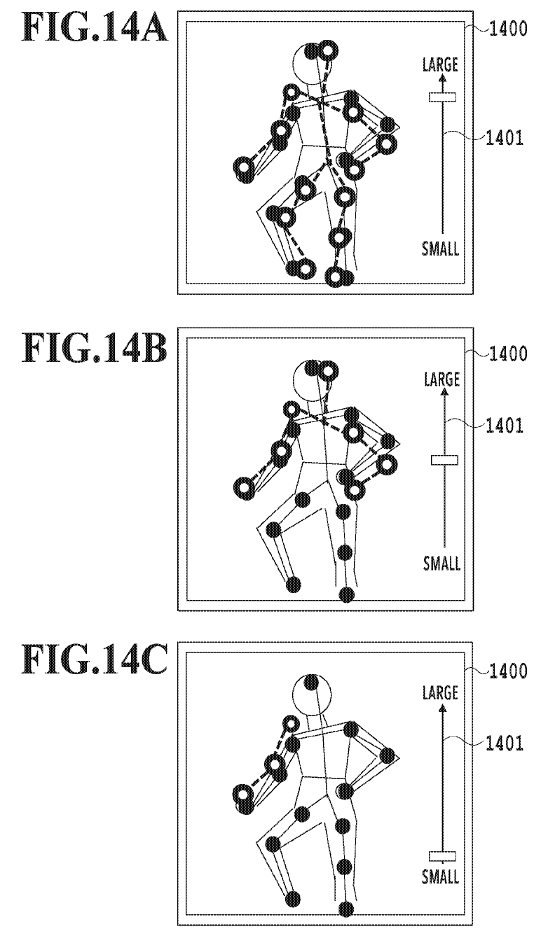

FIGS. 14A to 14C are diagrams illustrating an example of a pose instruction image 1400 corresponding to the alternative pose that is displayed on the display unit 205 according to the present embodiment. The pose instruction image 1400 includes a slider bar 1401. "Small" in the slider bar 1401 enables minimizing the movement of the target landmarks. In other words, "small" enables moving the target landmarks with the minimum burden imposed on the body of the person 103 as the subject. Imposing a burden on the body means that a value of the movement amount of each target landmark is set to the maximum value (including also the approximate maximum value) of the motion range stored in the skeleton motion range data or to a value slightly greater than the maximum value.

"Large" in the slider bar 1401 enables setting the number of the skeleton landmarks to be moved to the maximum while the burden imposed on the body is suppressed. Suppressing the burden imposed on the body means that, for example, an upper limit value of the movement amount of each target landmark is set to approximately the middle value of the motion range stored in the skeleton motion range data. For example, in a case where the motion range is 0 to 20 degrees, suppressing the burden imposed on the body means that the movement amount of the target landmark is set to approximately 0 to 10 degrees. A threshold to determine the upper limit value of the motion range is not limited to being approximately the middle value and may be provided in advance as a default value of the imaging apparatus 101 or may be inputted by the photographer 104.

In an exemplary case where a tab position of the slider bar 1401 is set to "large," the instruction obtainment unit 1005 executes the following described processing First, the instruction obtainment unit 1005 calculates the positions of the skeleton landmarks 1206 and 1207 after the movement in a case of moving the skeleton landmark 1202 to the position of the skeleton landmark 1201 such that the movement amount is around the middle value of the motion range of the skeleton landmark 1202. For example, the instruction obtainment unit 1005 uses the inverse-kinematic equation and calculates the positions of the skeleton landmarks 1206 and 1207 after the movement based on the three-dimensional angle and the length between the skeleton landmarks.

Next, in a case where the position of at least one of the skeleton landmarks 1206 and 1207 is changed in the above-described calculation result, the instruction obtainment unit 1005 calculates the position of another skeleton landmark connected with the skeleton landmark after the movement in a case of moving the skeleton landmark in the changed position such that the movement amount is approximately the middle value of the motion range by using the inverse-kinematic equation. Hereinafter, the above-described calculation is repeated until the positions of all the skeleton landmarks are determined. The above description is provided assuming that the instruction obtainment unit 1005 calculates the position of the skeleton landmark after the movement based on the skeleton motion range. The method of obtaining the position of the skeleton landmark after the movement is not limited thereto. For example, the instruction obtainment unit 1005 may obtain the position of the skeleton landmark such that the movement amounts of all the skeleton landmarks are approximately the middle value of the motion range by using a learned model obtained as a result of learning performed by deep learning.

FIG. 14A illustrates an example of the pose instruction image 1400 corresponding to the alternative pose in a case where the tab position of the slider bar 1401 is "large." Specifically, FIG. 14A illustrates the position of each skeleton landmark before the movement and the position of the skeleton landmark after the movement in a case where the burden imposed on the body of the person 103 as the subject is suppressed. As a result of considering the suppressing of the burden imposed on the body of the person 103, the movement of almost all the skeleton landmarks is instructed. FIG. 14C illustrates an example of the pose instruction image 1400 corresponding to the alternative pose in a case where the tab position of the slider bar 1401 is "small." Specifically, FIG. 14C illustrates the position of each skeleton landmark before the movement and the position of the skeleton landmark after the movement in a case where only a minimum-possible number of skeleton landmarks as targets are moved while the burden is imposed on the body of the person 103 as the subject. FIG. 14B illustrates an example of the pose instruction image 1400 corresponding to the alternative pose in a case where the tab position of the slider bar 1401 is in the middle between "large" and "small."

Turning back to FIG. 11, the imaging apparatus 101 executes the processing in S405 and transmits the data on the display image including the pose instruction image corresponding to the alternative pose generated in S1103 to the display device 102 via the network 105. After S405, the imaging apparatus 101 ends the processing in the flowchart illustrated in FIG. 11.

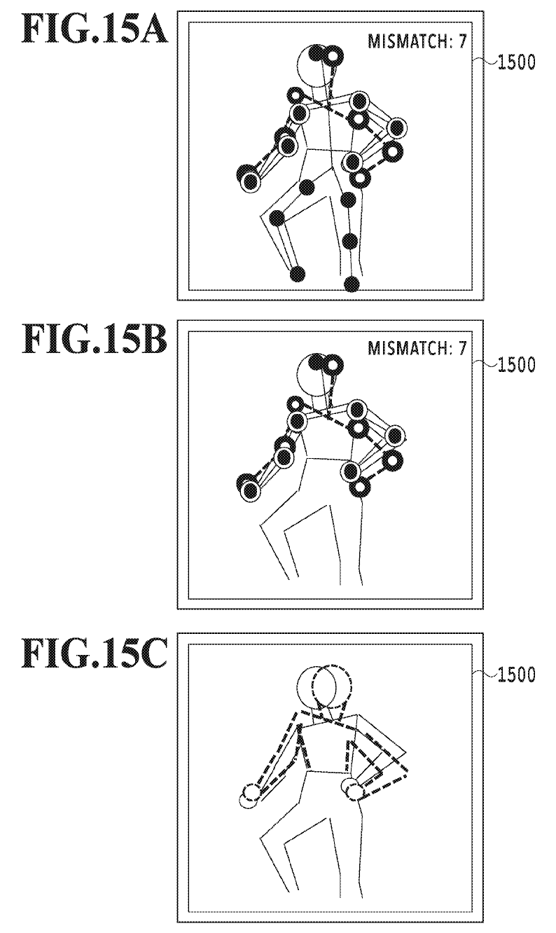

FIGS. 15A to 15C are diagrams illustrating an example of a display image 1500 displayed on the display unit 205 or the display unit 215 according to the present embodiment. The display image 1500 illustrated in FIGS. 15A, 15B, and 15C is the display image corresponding to each of the display images 900, 910, and 920 illustrated in FIGS. 9A, 9B, and 9D, respectively, and as such, the description is omitted herein.

According to the above-described imaging system , the person as the subject of an imaging operation may perceive how to change the person’s own posture. According to above-described imaging system, even in a case where the pose based on the pose instruction is the pose that can never be realized by the person, the pose instruction image may be generated and displayed based on a characteristic of the person as the subject. As a result, the photographer is provided assistance to properly perform an imaging operation.

### Embodiment 3

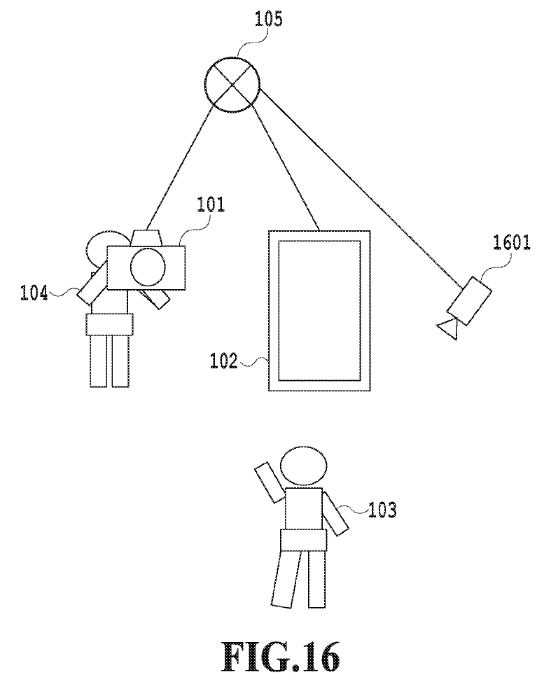

Embodiment 1 describes an aspect in which the display image is generated by using the live view image obtained by imaging from one direction. An Embodiment 3 describes an aspect in which the display image is generated by using multiple live view images obtained by imaging from multiple directions. FIG. 16 is a diagram illustrating an example of a configuration of the imaging system according to the present embodiment. The configuration of the imaging system according to the present embodiment is the same as the configuration of the imaging system according to Embodiment 1 except that an imaging apparatus 1601 that performs imaging of the person 103 as the subject from the above is added, for example. The imaging apparatus 1601 is an apparatus having an imaging function and a communication function such as a digital still camera, a digital video camera, or a smartphone.

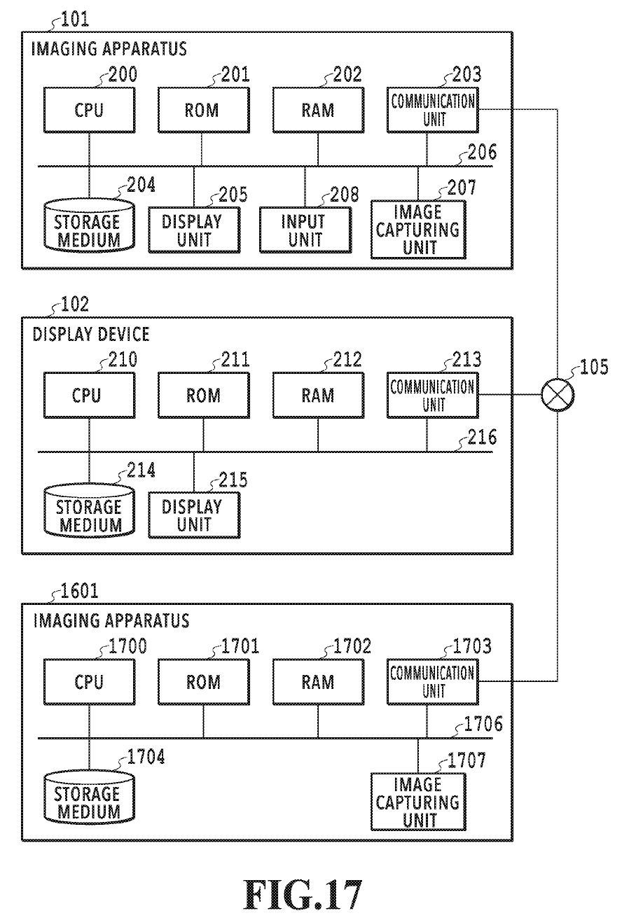

FIG. 17 is a diagram illustrating a hardware configuration of the imaging apparatus 101, the display device 102, and the imaging apparatus 1601 according to the present embodiment. The hardware configuration of the imaging apparatus 101 and the display device 102 according to the present embodiment is the same as the hardware configuration of the imaging apparatus 101 and the display device 102 according to Embodiment 1, and as such, the description is omitted herein. The imaging apparatus 1601 includes a CPU 1700, a ROM 1701, a RAM 1702, a communication unit 1703, a storage medium 1704, and an image capturing unit 1707. The components of the hardware configuration included in the imaging apparatus 1601 are communicably connected to each other via a bus 1706.

The CPU 1700 is a control unit that is at least one processor or circuit and controls the imaging apparatus 1601. The ROM 1701 is a memory that may perform deleting and recording electrically, and stores various data, programs, and the like used for processing by the CPU 1700. The program is a computer program for executing various flowcharts of the present embodiment as described below. The RAM 1702 is a memory used as a working area of the CPU 1700, and the data used for the processing by the CPU 1700, the program read out from the ROM 1701, and the like are loaded into the RAM 1702.

The communication unit 1703 is an interface for communication with an external device such as network equipment or a USB device and establishes data communication via the network 105 or transmits and receives data to and from the external device. The storage medium 1704 is a non-volatile recording medium such as a semiconductor memory or the like such as a memory card. The image capturing unit 1707 is an image capturing element such as a CCD, a CMOS element, or the like that converts an optical image into an electric signal. The CPU 1700 also operates as a control unit that controls the image capturing unit 1707.

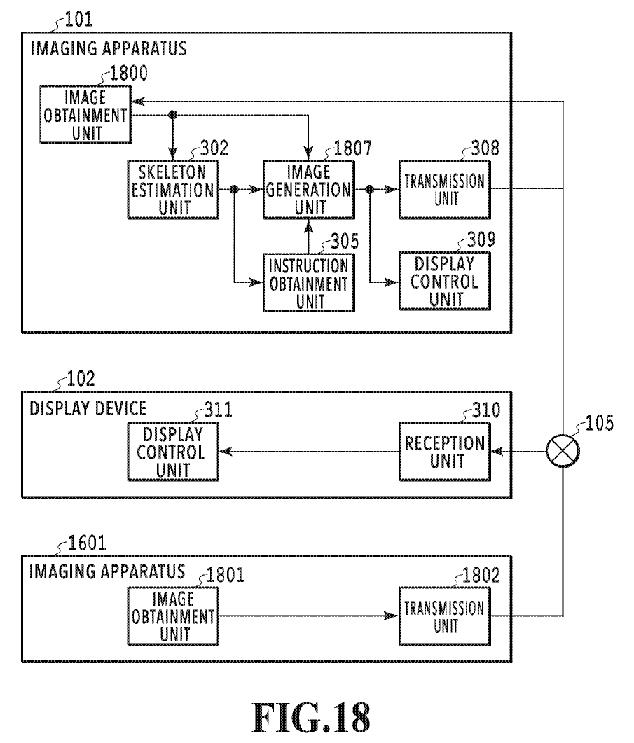

FIG. 18 is a block diagram illustrating an example of a logical configuration of the imaging apparatus 101, the display device 102, and the imaging apparatus 1601 according to the present embodiment. The logical configuration of the imaging apparatus 1601 includes an image obtainment unit 1801 and a transmission unit 1802. The image obtainment unit 1801 obtains the image obtained by an imaging operation by the image capturing unit 1707 as the live view image and saves data of the obtained live view image into the storage medium 1704. The transmission unit 1802 transmits the data of the live view image obtained by the image obtainment unit 1801 to the imaging apparatus 101 via the network 105. The imaging apparatus 101 according to the present embodiment includes an image obtainment unit 1800 and an image generation unit 1807, which are different from the image obtainment unit 300 and the image generation unit 307 of the imaging apparatus 101 of Embodiment 1, respectively. The image generation unit 1807 obtains the live view image transmitted from the imaging apparatus 1601 in addition to the live view image obtained by an imaging operation by the image capturing unit 207. Details of the processing executed by the image generation unit 1807 are described below. The logical configuration of the display device 102 according to the present embodiment is the same as the logical configuration of the display device 102 according to Embodiment 1, and as such, the description is omitted herein.

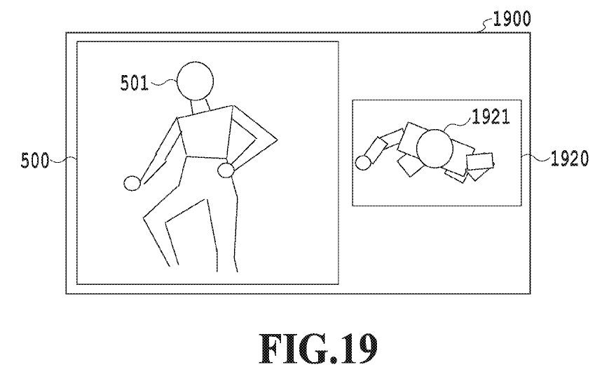

A flow of processing by the imaging apparatus 101 according to the present embodiment will be described with reference to FIG. 4. Description of processing similar to the processing according to Embodiment 1 is omitted herein. In S400, the image obtainment unit 1800 obtains the live view image obtained by imaging by the image capturing unit 207 and the live view image transmitted from the imaging apparatus 1601. Data on the live view image obtained by the image obtainment unit 1800 is saved into the storage medium 204. The live view image obtained by the image obtainment unit 1800 is displayed on the display unit 205 via the display control unit 309. FIG. 19 is a diagram illustrating an example of a live view image 1900 displayed on the display unit 205 according to the present embodiment. The live view image 1900 includes the live view image 500 illustrated in FIG. 5 and a live view image 1920 obtained from the imaging apparatus 1601. The live view image 1920 includes a representation 1921 of the person 103 as the subject.

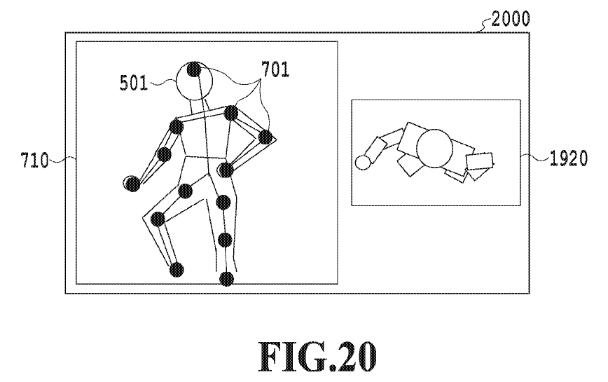

Returning to FIG. 4, the imaging apparatus 101 executes the processing in S401. Next, in S402, the image generation unit 1807 generates the skeleton landmark image obtained by converting the skeleton landmark data obtained in S401 into the form of an image. The skeleton landmark image generated by the image generation unit 1807 is displayed on the display unit 205 via the display control unit 309. The image generation unit 1807 may generate the image obtained by superimposing the generated skeleton landmark image on the live view image obtained in S400. In this case, the image generated by the image generation unit 1807 is displayed on the display unit 205 via the display control unit 309. FIG. 20 is a diagram illustrating an example of a skeleton landmark image 2000 displayed on the display unit 205 according to the present embodiment. The skeleton landmark image 2000 includes the skeleton landmark image 710 generated by superimposing the skeleton landmark image 700 on the live view image 500 and the live view image 1920 obtained from the imaging apparatus 1601.

The present embodiment is described assuming that the skeleton estimation based on the live view image 1920, that is, the live view image obtained from the imaging apparatus 1601 is not performed. This is not seen to be limiting. For example, the skeleton estimation unit 302 may execute the skeleton estimation processing using the skeleton estimation DL model on the live view image obtained from the imaging apparatus 1601. In this case, the image generation unit 1807 may generate the landmark image by also converting the skeleton landmark data obtained as a result of the skeleton estimation processing into the form of an image. The image generation unit 1807 may generate the image obtained by superimposing the generated landmark image on the live view image obtained from the imaging apparatus 1601 and may display the image on the display unit 205 via the display control unit 309.

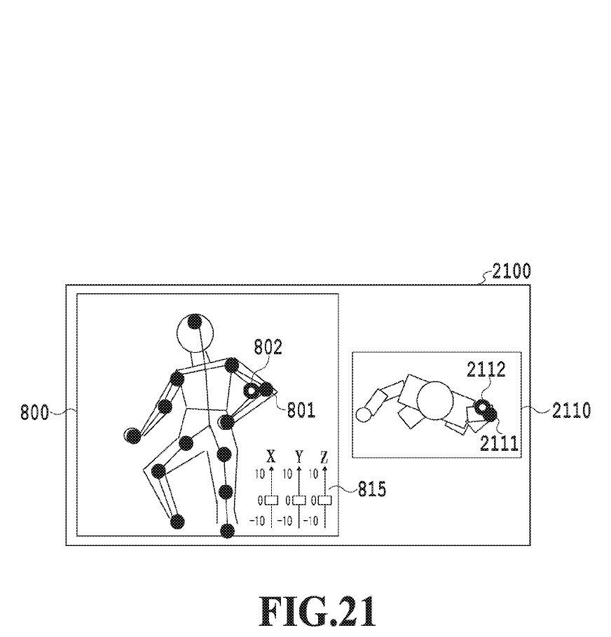

The imaging apparatus 101 then executes the processing in S403. FIG. 21 is a diagram illustrating an example of a pose instruction input screen 2100 displayed on the display unit 205 according to the present embodiment. The pose instruction input screen 2100 includes the image corresponding to the pose instruction input screen 800 illustrated in FIG. 8B. As an example, the photographer 104 touches an arbitrary skeleton landmark from the multiple skeleton landmarks displayed in the skeleton landmark image 700 illustrated in FIG. 20 and selects the skeleton landmark as the target landmark.

In a case where the skeleton landmark 801 is selected as the target landmark, the imaging apparatus 101 displays the skeleton landmark 802 for the pose instruction near the skeleton landmark 801. The imaging apparatus 101 displays the slider bar 815 to input the movement amount in the direction of each axis as the GUI component for the pose instruction. The imaging apparatus 101 displays an image 2110 obtained by superimposing a skeleton landmark 2111 corresponding to the skeleton landmark 801 and a skeleton landmark 2112 for the pose instruction corresponding to the skeleton landmark 802 on the live view image 1920 on the pose instruction input screen 2100. Positions of the skeleton landmarks 2111 and 2112 may be calculated by calibrating a positional relationship between the imaging apparatus 1601 and the imaging apparatus 101 in advance.

Once the skeleton landmark 802 for the pose instruction is moved by an input by the photographer 104, along with the movement, the skeleton landmark 2112 for the pose instruction corresponding to the skeleton landmark 802 is also moved. Once the skeleton landmark 2112 for the pose instruction is moved by an input by the photographer 104, along with the movement, the skeleton landmark 802 for the pose instruction corresponding to the skeleton landmark 2112 is also moved. Thus, the photographer 104 may intuitively determine the three-dimensional position of the skeleton landmark for the pose instruction and may designate the movement or the position.

Next, in S404, the image generation unit 1807 generates the pose instruction image by using the live view image, the pose instruction data, and the skeleton landmark data obtained in S400, S401, or S403. The pose instruction image generated by the image generation unit 1807 is displayed as the display image on the display unit 205 via the display control unit 309. In S405, the transmission unit 308 transmits the data on the display image generated in S404 to the display device 102 via the network 105. The display device 102 receives the data on the display image transmitted in S405 and displays the display image on the display unit 215 to the person 103 as the subject.

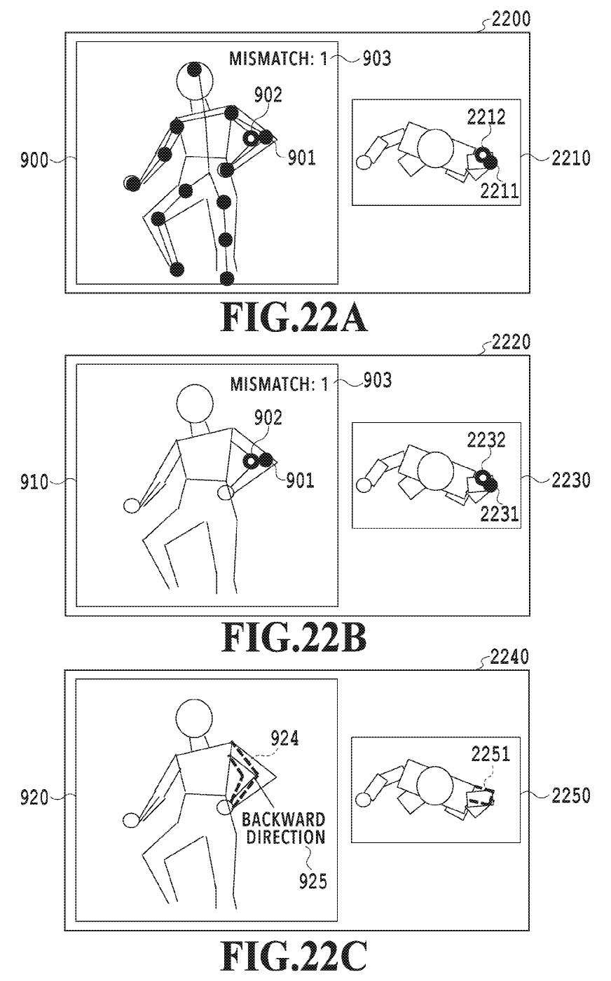

FIGS. 22A to 22C are diagrams illustrating an example of the display image displayed on the display unit 205 or the display unit 215 according to the present embodiment. A display image 2200 illustrated in FIG. 22A includes the display image 900 illustrated in FIG. 9A and a display image 2210 generated based on the live view image 1920. The display image 2200 is the same as the pose instruction input screen 2100 illustrated in FIG. 21 from which the GUI component for the pose instruction is removed. That is, a target landmark 2211 and a skeleton landmark 2212 for the pose instruction correspond to the target landmark 901 and the skeleton landmark 902 for the pose instruction.

A display image 2220 illustrated in FIG. 22B includes the display image 910 illustrated in FIG. 9B and a display image 2230 generated based on the live view image 1920. In the display image 2220, only the target landmark and the skeleton landmark for the pose instruction are displayed from the estimated skeleton landmarks. A target landmark 2231 and a skeleton landmark 2232 for the pose instruction correspond to the target landmark 901 and the skeleton landmark 902 for the pose instruction. A display image 2240 illustrated in FIG. 22C includes the display image 920 illustrated in FIG. 9C and a display image 2250 generated based on the live view image 1920. In the display image 2240, instead of the target landmark and the skeleton landmark for the pose instruction, a body line 2251 in a case of moving the skeleton landmark according to the pose instruction is displayed while being superimposed on the live view image 1920.

According to the above-described imaging system of the present embodiment, the person as the subject may perceive how to change the person’s own posture. According to the above-described imaging system, the person as the subject may confirm how to change the person’s own posture by seeing the images from the multiple directions. As a result, the photographer is assisted in properly performing an imaging operation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-204635, filed November 25, 2024, which is hereby incorporated by reference herein in its entirety.

What is claimed is:

1. An imaging apparatus, comprising:
one or more hardware processors; and
one or more memories storing one or more programs that when executed by the one or more hardware processors causes the imaging apparatus to:
estimate a plurality of skeleton landmarks in a representation of a person to be imaged included in a captured image;
obtain a pose change instruction based on designation of a position after movement of at least one of the skeleton landmarks by a user;
generate a pose instruction image corresponding to the pose change instruction; and
transmit the pose instruction image to a display device viewable by the person to be imaged.

2. The imaging apparatus according to claim 1, wherein the obtained pose change instruction is based on an input by the user designating a direction in which the skeleton landmark is to be moved.

3. The imaging apparatus according to claim 2, wherein the direction in which the skeleton landmark is to be moved is at least a vertical direction or, a horizontal direction in the captured image or a direction orthogonal to a plane corresponding to the captured image.

4. The imaging apparatus according to claim 3, wherein the pose instruction image is an image expressing a movement amount to move the skeleton landmark in a frontward or backward direction in the orthogonal direction in a case where the user inputs the orthogonal direction as the direction in which the skeleton landmark is to be moved.

5. The imaging apparatus according to claim 1, wherein the pose instruction image is an image in which expression of at least a shape, a color, or transparency of the skeleton landmark is changed in a case where the skeleton landmark is moved to the position after the movement that is designated by the user.

6. The imaging apparatus according to claim 1, wherein the imaging apparatus is further caused determine, based on a skeleton motion range and an angle and a length between the skeleton landmarks, whether only the skeleton landmark may be moved to the position after the movement that is designated by the user.

7. The imaging apparatus according to claim 6,
wherein the imaging apparatus is further caused to obtain, in a case where it is determined that it is not possible to move only the skeleton landmark to the position after the movement, a candidate for a position to which the skeleton landmark is movable based on the skeleton motion range and the angle and the length between the skeleton landmarks, and
wherein the pose instruction image is generated based on the candidate.

8. The imaging apparatus according to claim 1, wherein the pose instruction image is an image expressing at least the skeleton landmark from among the plurality of estimated skeleton landmarks.

9. The imaging apparatus according to claim 1, wherein the pose instruction image is an image expressing only the skeleton landmark from among the plurality of estimated skeleton landmarks.

10. The imaging apparatus according to claim 1, wherein the pose instruction image is an image expressing a posture of the person to be imaged in a case where the skeleton landmark is moved to the position after the movement that is designated by the user.

11. The imaging apparatus according to claim 1, wherein the imaging apparatus is further caused to display the pose instruction image on a display device of the imaging apparatus viewable by the user.

12. The imaging apparatus according to claim 11, wherein the pose instruction image to be displayed on the display device of the imaging apparatus and the pose instruction image to be transmitted to the display device are in different forms.

13. A method for controlling an imaging apparatus, the method comprising:
estimating a plurality of skeleton landmarks in a representation of a person to be imaged included in a captured image;
obtaining a pose change instruction based on designation of a position after movement of at least one of the skeleton landmarks by a user;
generating a pose instruction image corresponding to the change instruction; and
transmitting the pose instruction image to a display device viewable by the person to be imaged.

14. A non-transitory computer readable storage medium storing a program for causing a computer to perform a method fort controlling an imaging apparatus, the method comprising:
estimating a plurality of skeleton landmarks in a representation of a person to be imaged included in a captured image;
obtaining a pose change instruction based on designation of a position after movement of at least one of the skeleton landmarks by a user;
generating a pose instruction image corresponding to the change instruction; and
transmitting the pose instruction image to a display device viewable by the person to be imaged.
